(19) United States
(12) Patent Application Publication
(10) Pub. No.: US 2021/0397957 A1
(43) Pub. Date: Dec. 23, 2021

(54) MULTI-PROCESSOR TRAINING OF NEURAL NETWORKS

(71) Applicant: Apple Inc., Cupertino, CA (US)

(72) Inventors: Umesh S. VAISHAMPAYAN, Santa Clara, CA (US); Kit-Man WAN, Sunnyvale, CA (US); Aaftab A. MUNSHI, Los Gatos, CA (US); Cecile M. FORET, Palo Alto, CA (US); Yen-Fu LIU, Pleasanton, CA (US)

(21) Appl. No.: 17/349,843

(22) Filed: Jun. 16, 2021

Related U.S. Application Data
(60) Provisional application No. 63/041,004, filed on Jun. 18, 2020.

(51) Int. Cl. G06N 3/08; G06N 3/063; G06K 9/62

(52) U.S. Cl. CPC G06N 3/08; G06K 9/6202; G06N 3/063

(57) ABSTRACT

The subject technology provides a framework for multi-processor training of neural networks. Multi-processor training of neural networks can include performing a forward pass of a training iteration using a neural processor, and performing a backward pass of the training iteration using a CPU or a GPU. Additional operations for facilitating the multi-processor training are disclosed.

### CROSS REFERENCE TO RELATED APPLICATIONS

This application claims the benefit of priority to U.S. Provisional Patent Application No. 63/041,004, entitled “Multi-Processor Training Of Neural Networks,” filed on Jun. 18, 2020, the disclosure of which is hereby incorporated herein in its entirety.

### TECHNICAL FIELD

The present description generally relates to training of machine learning models and, or particularly, to multi-processor training of neural networks.

### BACKGROUND

Software engineers and scientists have been using computer hardware for machine learning to make improvements across different industry applications. Machine learning for mobile devices has often be performed off-device, such as at a cloud server, to preserve computing resources and power at the mobile device.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 illustrates an example computing architecture for a system providing multi-processor training of neural networks in accordance with one or more implementations.

FIG. 3 illustrates a schematic diagram of an example process for training a neural network using a central processing unit in accordance with one or more implementations.

FIG. 4 illustrates a schematic diagram of a trained machine learning model running on a neural processor in accordance with one or more implementations.

FIG. 5 illustrates a diagram of power consumption over time for a training operation for a neural network using central processing unit in accordance with one or more implementations.

FIG. 6 illustrates a schematic diagram of an example process for multi-processor training of a neural network in accordance with one or more implementations.

FIG. 7 illustrates a diagram of power consumption over time for a training operation for a neural network using a neural processor in accordance with one or more implementations.

FIG. 8 illustrates a flow diagram of an example process for multi-processor training of neural networks in accordance with one or more implementations.

FIG. 9 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Machine learning has seen a significant rise in popularity in recent years due to the availability of massive amounts of training data, and advances in more powerful and efficient computing hardware. Machine learning may utilize models such as neural networks that are trained and then executed to provide predictions in particular applications (e.g., analyzing images and videos, voices, object detection and/or tracking, etc.) among many other types of applications. Machine learning models such as neural networks are often trained and/or executed at a server, with the results being provided to an end-user device such as a user's home computer, laptop computer, tablet computer, mobile phone, or wearable device such as a smart watch (as examples.)

In some implementations, end-user devices can be provided with dedicated processing circuitry for executing trained machine learning models at the device. This dedicated processing circuitry can be referred to as a neural processor, and may be provided in addition to more general processing circuitry of the device such as a central processing unit (CPU), and/or in addition to other specialized processing circuitry of the device such as a graphics processing unit (GPU) that is optimized for processing graphics content for display.

In end-user devices that include neural processors, the machine learning models that are executed by the neural processors are often trained by a separate device or system (e.g., a remote server) or a using the CPU of the device, since training operations for neural networks may include operations for which a neural processor is not optimized. For example, training operations for neural networks often include backward passes through the network in which gradients are computed. Gradient computations may be more efficiently processed by a CPU than a neural processor.

In accordance with one or more implementations of the subject technology, power and/or time savings can be provided for training of neural networks (e.g., on mobile devices) by performing a forward pass of each training run with a neural processor, and a backward pass of each training run on a GPU or CPU. Because the neural processor may be optimized for inference, the forward pass of the training can be efficiently run on the neural processor. The forward pass of the neural network may include evaluating fully connected layers, activation functions, and the like at various nodes of the neural network, using a current set of parameters such as weights and biases. The backward pass of a training run for a neural network may include other operations (e.g., loss calculations and/or gradient calculations) that are not performed during the forward pass, and that may not be calculated efficiently with the neural processor. Challenges in implementing this multi-processor training are addressed herein.

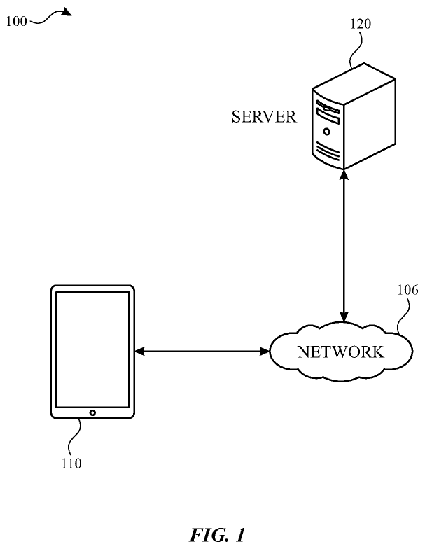

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110 and a server 120. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, and the server 120; however, the network environment 100 may include any number of electronic devices and any number of servers.

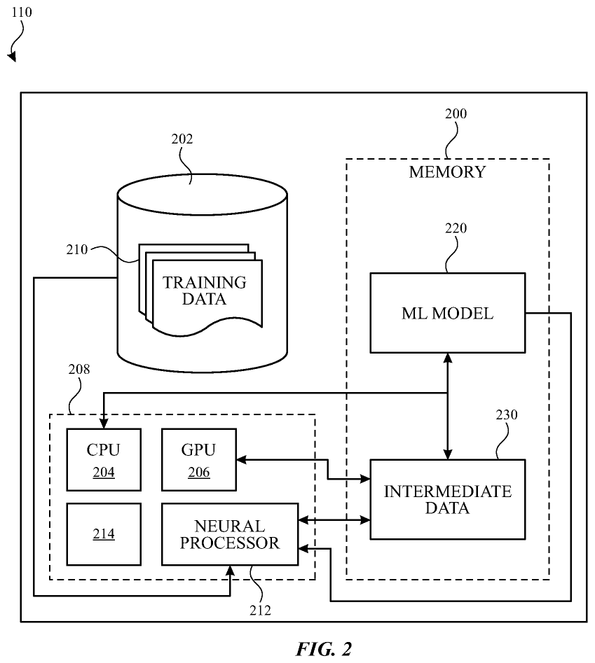

The electronic device 110 may be, for example, a desktop computer, a portable computing device such as a laptop computer, a smartphone, a peripheral device (e.g., a digital camera, headphones), a tablet device, a wearable device such as a smart watch, a smart band, and the like. In FIG. 1, by way of example, the electronic device 110 is depicted as a mobile electronic device (e.g., a smartphone). The electronic device 110 may be, and/or may include all or part of, the electronic system discussed below with respect to FIG. 2 and/or FIG. 9.

In one or more implementations, the electronic device 110 may provide a system for training a machine learning model using training data, where the trained machine learning model is subsequently executed at the electronic device 110 (and/or at another electronic device). Further, the electronic device 110 may provide one or more machine learning frameworks for training machine learning models and/or developing applications using such machine learning models. In an example, such machine learning frameworks can provide various machine learning algorithms and models for different problem domains in machine learning. In an example, the electronic device 110 may include a deployed machine learning model that provides an output of data corresponding to a prediction or some other type of machine learning output. In an implementation, the electronic device 110 utilizes the trained machine learning model and continually learns/re-trains the model over time.

FIG. 2 illustrates an example computing architecture for a system providing multi-processor training of neural networks, in accordance with one or more implementations. For explanatory purposes, the computing architecture is described as being provided by the electronic device 110; however, the computing architecture may be implemented by any other electronic devices, such as desktop computers, laptop computers, wearable devices, tablet computers, or the like. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As illustrated, the electronic device 110 may include memory 200 storing a machine learning (ML) model 220. The ML model 220 may be a trained machine learning model that includes parameters (e.g., weights, biases, etc., associated with nodes of a neural network) that have been trained at the electronic device 110 using the processes described herein.

Electronic device 110 may include memory 202 storing training data 210 for training the machine learning model 220. The training data 210 may include input training data that can be provided as input to the machine learning model, and output training data that can be compared to the output of the machine learning model during training. Training data 210 may be generated at electronic device 110 (e.g., using a camera, a depth sensor, a microphone, a inertial measurement unit, etc. of the electronic device) and/or obtained from another device such as from server 120 before and/or during training operations.

Training the machine learning model may include performing various training runs (also referred to herein as training iterations) using the training data 210. Each training run may include executing a forward pass of the machine learning model to obtain a model output based on at least a portion of the input training data and a given set of parameters, and executing a backward pass of the machine learning model to update the set of parameters for the next training run (e.g., based on a comparison of the model output and output training data corresponding to the portion of the input training data, and based on gradient computations of the backward pass).

In the example of FIG. 2, electronic device 110 includes processing circuitry 208. As shown, processing circuitry 208 can include a central processing unit 204 (e.g., a CPU) and a graphics processing unit 206 (e.g., a GPU). In the example of FIG. 2, processing circuitry 208 also includes a neural processor 212 that is optimized for executing machine learning models such as ML model 220 to generate model output data from input data provided to the model. As shown in FIG. 2, processing circuitry 208 may also include local memory 214 in one or more implementations.

In the example of FIG. 2, the CPU 204, the GPU 206, and the neural processor 212 are disposed in a common electronic device (e.g., electronic device 110). It should also be appreciated that, in one or more implementations, the neural processor 212 may cooperate with a CPU and/or a GPU at another device (e.g., a laptop computer, a desktop computer, or any other electronic device having processing circuitry and communications circuitry for communicating with electronic device 110) for training a neural network.

In one or more implementations, processing circuitry 208 may be implemented using multiple separate chips corresponding to the CPU 204, the GPU 206, and the neural processor 212. In one or more implementations, processing circuitry 208 may be formed from a single processor complex with different core types or multiple processors of differing types. For example, a processor complex may include a multiprocessing system having multiple clusters of cores, each cluster having one or more cores of a core type, interconnected with one or more buses and/or a memory fabric interconnect.

For example, a memory fabric interconnect may be included in the processing complex to communicatively couple, e.g., interconnect, the different cores and/or processors of the processor complex. In various implementations, a processor complex may include a symmetric multiprocessing system (SMP) having clusters of a same core type where at least one cluster of cores is configured differently from at least one other cluster of cores. Cluster configurations can include, e.g., different configurations of dynamic voltage and frequency scaling (DVFS) states, different cache hierarchies, or differing amounts or speeds of cache. In various implementations, a processor complex may also include an asymmetric multiprocessing system (AMP) having clusters of cores where at least one cluster of cores has a different core type than at least one other cluster of cores. Each cluster can have one or more cores. Core types can include performance cores (e.g., P-cores), efficiency cores (e.g., E-cores), graphics cores (e.g., for GPU 206), digital signal processing cores, arithmetic processing cores, neural processing cores (e.g., for neural processor 212), or generally any type of processing cores. In one or more implementations, the processor complex may be and/or may include a system on a chip (SoC) that may include one or more of the hardware elements in the processing circuitry 208 of FIG. 2.

As shown in the example of FIG. 2, memory 200 may also store intermediate data 230 generated by the neural processor 212, the CPU 204, and/or the GPU 206 during training of a neural network (e.g., to generate the trained ML model 220). In one or more implementations, portions of the intermediate data 230 generated by the neural processor 212 during a training run can be stored in memory 200 for access by CPU 204 and/or the GPU 206 for a subsequent stage (e.g., a backward pass) of the training run. In one or more implementations, portions of the intermediate data 230 generated by the CPU 204 and/or the GPU 206 during a training run can be stored in memory 200 for access by neural processor 212 for a subsequent training run. In one or more implementations, some or all of the intermediate data 230 can be stored in the local memory 214 that is local to processing circuitry 208 (e.g., on the same SoC) and commonly accessible by the CPU 204, the GPU 206, and the neural processor 212 during training operations.

A final set of parameters resulting from the training operations can be provided by processing circuitry 208 (e.g., by CPU 204) for storage in memory 200 to define the trained ML model 220. Once the ML model 220 is trained, the model can be executed by neural processor 212 to generate output data from input data provided to the trained model for any of various machine learning operations for which the model has been trained.

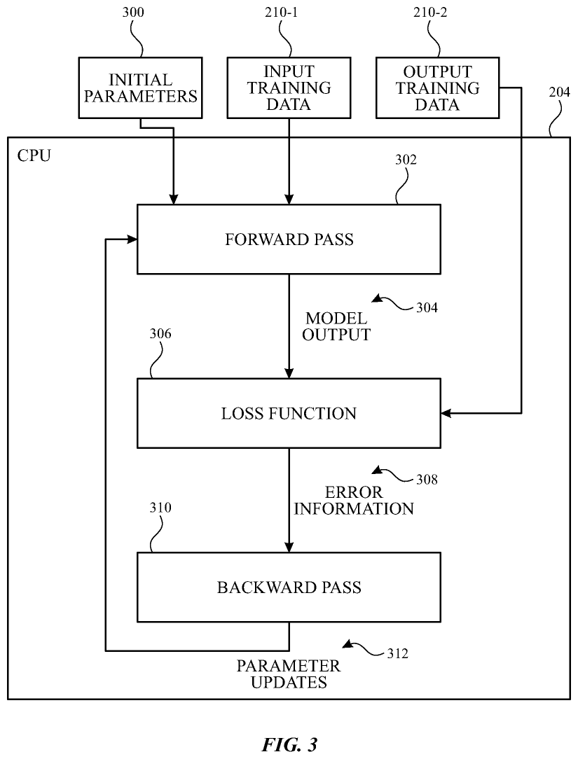

FIG. 3 illustrates a training operation that can be performed by CPU 204 to train a neural network (e.g., to define a trained ML model such as ML model 220 of FIG. 2). In the example of FIG. 3, a set of initial (e.g., untrained) parameters (e.g., weights, biases, etc.) such as initial parameters 300 can be provided, along with input training data 210-1 to CPU 204 for execution of a forward pass 302 of a machine learning model such as a machine learning model implementing a neural network.

Using the initial parameters 300, the forward pass 302 of the model generates a model output 304. Executing a forward pass of a neural network may include, for example, applying weights and/or biases at each of one or more corresponding nodes of each of one or more layers of the neural network, and computing the result of an activation function for each node. The model output 304 can be compared with a desired model output for the input training data 210-1, the desired model output included in a portion of the output training data 210-2 that corresponds to the input training data used to generate the model output. For example, a loss function 306 (also referred to as a cost function) can be used to quantify the difference between the model output 304 and the desired model output. Error information 308, which can include the result of the loss function and/or gradient information for the loss function (e.g., based on a derivative of the loss function), can be generated by the CPU 204 for execution of a backward pass 310 of the model by the CPU 204.

Executing the backward pass 310 of the model may include computations of partial derivatives of the loss function 306 with respect to the weights and/or biases used in the forward pass, to backpropagate model errors through the layers of the neural network in reverse order. This backpropagation results in parameter updates 312 (e.g., updated parameters and/or parameter deltas to be applied to the previous set of parameters) that can be used to reduce the error/loss for a next training run (e.g., training iteration). The process illustrated in FIG. 3 can be repeated for multiple training iterations until convergence of the model parameters to form a trained model such as ML model 220 of FIG. 2.

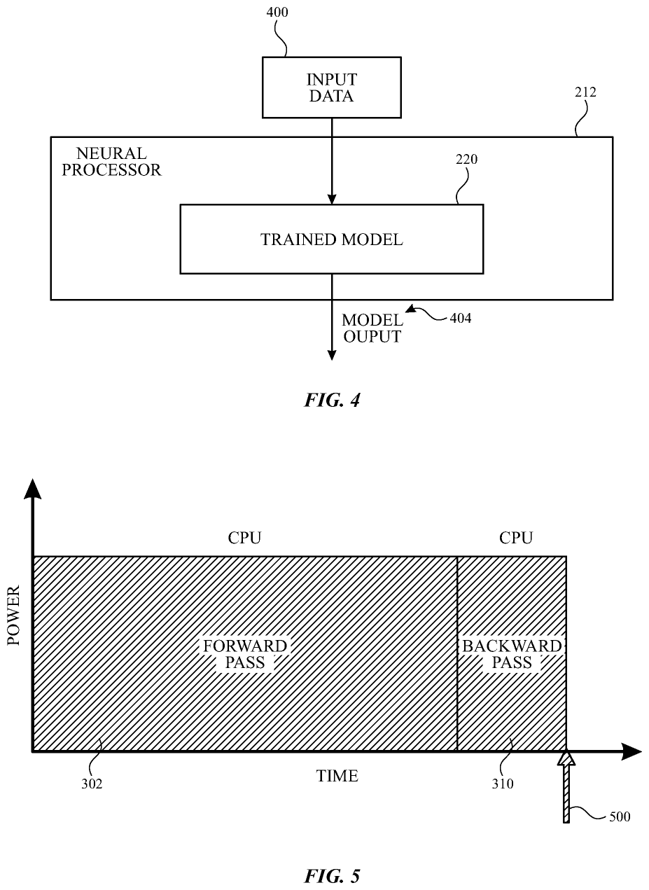

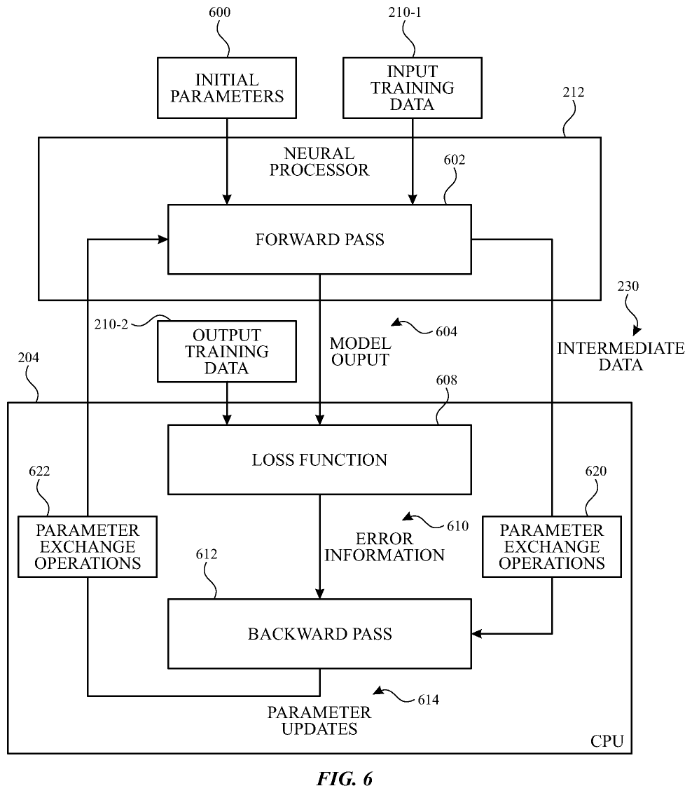

Once a model is trained (e.g., as described above in connection with FIG. 3 or using a multi-processor training process as described below in connection with FIGS. 6-8), the neural processor 212 can be used for efficient runtime operations of the trained ML model 220. For example, FIG. 4 illustrates how input data 400 can be provided to neural processor 212 for execution of the trained ML model 220 to generate a model output 404. In one or more implementations, input data 400 may be, as illustrative examples, image information corresponding to a face of a user, sensor information corresponding to a fingerprint of a user, or audio input from a user, and model output 404 may be a binary output indicating whether the user is an authorized user of electronic device 110.

Because the computations performed during a forward pass and a backward pass of a neural network are different (as described above in connection with FIG. 3), the times for performing the forward pass 302 and the backward pass 310 of the model for each training run are different when performed by the CPU 204. For example, FIG. 5 illustrates a time-power diagram corresponding to the example process of FIG. 3. Although the instantaneous power consumed by the CPU 204 would vary over time, FIG. 5 illustrates a substantially constant representative amount of power (an average amount of power or a median amount of power) that may be consumed by the CPU 204 during forward pass 302 and backward pass 310. In this simplified diagram, it can be seen that the forward pass may take substantially more time for the CPU to execute than backward pass 310. This is because the hardware architecture of the CPU 204 is more efficient for the computations of the backward pass 310 than the computations of the forward pass 302. As illustrated in FIG. 5, each training run can take a total time 500 to complete.

In one or more implementations of the subject technology, a multi-processor process for training a neural network can reduce the time and/or the power used for the training. The multi-processor training may use a neural processor such as neural processor 212 to perform a forward pass of the model, and use a CPU or GPU (e.g., CPU 204 or GPU 206) to perform a backward pass of the model. FIG. 6 illustrates an example of a process for multi-processor training of a neural network. The process of FIG. 6 addresses various technical challenges that can arise in implementing such a multi-processor training process.

As illustrated in the example of FIG. 6, processing circuitry such as processing circuitry 208 of FIG. 2 may provide input training data 210-1 to a neural processor such as neural processor 212. The input training data 210-1 for each iteration or training operation may be referred to as a mini batch of the input training data. A set of initial parameters 600 (e.g., an initial set of weights, biases, and/or other parameters of a machine learning model implementing a neural network) can also be provided to the neural processor.

In one or more implementations, the neural processor and the CPU and/or GPU are implemented in the same device. (e.g., a mobile phone, a tablet, a laptop, a wearable device, a desktop computer, a smart speaker, a set top box, or the like) In other implementations, the neural processor is implemented in a first device (e.g., a mobile phone, a tablet, a laptop, or a wearable device, a smart speaker, a set top box, or the like) and the CPU and/or GPU are implemented at a second device (e.g., a laptop or desktop computer or the like). In one or more implementations, the set of initial parameters 600 (e.g., an initial set of weights, biases, and/or other parameters of a machine learning model implementing a neural network) and the training data can be provided to the neural processor from processing circuitry at the same device, or from processing circuitry at another device.

As indicated in FIG. 6, the neural processor 212 executes a forward pass 602 of a training operation for the neural network using the input training data. Executing the forward pass 602 of the neural network may include applying weights and/or biases at each of one or more corresponding nodes of each of one or more layers (e.g., by multiplying the input training data by a weight matrix of the weights for that layer, and adding the biases for that layer), and computing the result of an activation function (e.g., a rectified linear unit, or ReLU) for each node. The forward pass 602 of the training operation results in a model output 604 that can be provided from the neural processor 212 to the CPU 204 (or to the GPU 206).

As indicated in FIG. 6, the CPU 204 (or the GPU 206) receives, responsive to the input training data being provided to the neural processor, output data (e.g., the model output 604) from the neural processor, the output data being a result of the forward pass of the training operation for the neural network using the input training data. The model output 604 can be compared with a desired model output for the input training data 210-1, the desired model output included in output training data 210-2 that is provided to CPU 204 (or GPU 206). For example, a loss function 608 or a cost function can be used to quantify the difference between the model output 604 and the desired model output in the output training data 210-2. Applying the loss function 608 may include applying a first function that maps the model output 604 to a vector in a desired range (e.g., in a range from zero to one such as by applying a softmax function), and a applying a second function (e.g., a cross entropy loss function) to the result of the first function. Error information 610, which can include the result of the loss function 608 and/or gradient information for the loss function (e.g., based on one or more derivatives of the loss function) can be provided (e.g., to a previous layer of the neural network) for execution of a backward pass 612 of the model by the CPU 204.

The CPU 204 (or the GPU 206) may then perform the backward pass 612 of the training operation for the neural network. However, as indicated in FIG. 6, performing the backward pass 612 at the CPU 204 (or GPU 206) following a forward pass 602 performed at the neural processor 212 may require additional data access and/or processing operations for the execution of the backward pass 612. For example, as illustrated in FIG. 6, intermediate data 230 generated during the forward pass 602 may also be provided to the CPU 204 (or the GPU). The intermediate data 230 may include the results of internal computations (e.g., vectors, tensors, etc. computed at the nodes of the neural network during the forward pass) that would not otherwise be output by the model undergoing training (e.g., if the training by were performed a single processor or a core of processors of the same type), but that may be needed to compute the partial derivatives of the backward pass gradient calculations.

The intermediate data 230 may also include the values of the parameters used in the forward pass 602 to generate the model output 604. In one or more implementations, the CPU 204 or the GPU 206 may be arranged to utilize a first data layout and to perform floating point computations with a first precision, and the neural processor 212 may be arranged to utilize a second data layout (e.g., different from the first data layout) and to perform floating point computations with a second precision. In one or more implementations, the first precision may be higher than the second precision. In one or more implementations, the CPU 204 (or the GPU 206) may perform parameter exchange operations 620 to modify the set of parameters and/or other intermediate data used by the neural processor 212 to perform the forward pass 602 (e.g., using the second data layout and the second precision), for use (e.g., using the first data layout and the first precision) by the CPU 204 (or the GPU 206) in the backward pass 612.

Executing the backward pass 612 of the model may include computations of partial derivatives of the loss function 608 with respect to the weights and/or biases used in the forward pass 602, to backpropagate model errors through the layers of the neural network in reverse order. This backpropagation results in parameter updates 614 (e.g., updated parameters and/or parameter deltas to be applied to the previous set of parameters) that can be used to reduce the error/loss for a next training run (e.g., training iteration).

Following the backward pass 612, the CPU 204 (or the GPU 206) may also perform parameter exchange operations 622 to modify (e.g., to account for computational precision differences between the neural processor 212 and the CPU 204 and/or GPU 206, and/or to account a different data layout for neural engine 212 and the CPU/GPU) the updated set of parameters based on the parameter updates 614 from the central processing unit or the graphics processing unit, for use in computations with the second precision and/or using the second data layout by the neural processor 212 (e.g., during the next training run or iteration).

Intermediate data 230 generated by the neural processor 212 during the forward pass 602 of the training operation may be stored in memory 200 or 214 for access by the CPU 204 (or the GPU 206) during the backward pass, in one or more implementations. The process illustrated in FIG. 6 can be repeated over multiple iterations or training runs until convergence of the model parameters to form a trained model such as ML model 220 of FIG. 2. Once a machine learning model is trained using the processes illustrated in FIG. 6, the trained model (e.g., ML model 220) can be executed at runtime by the neural processor 212, as described above in connection with FIG. 4.

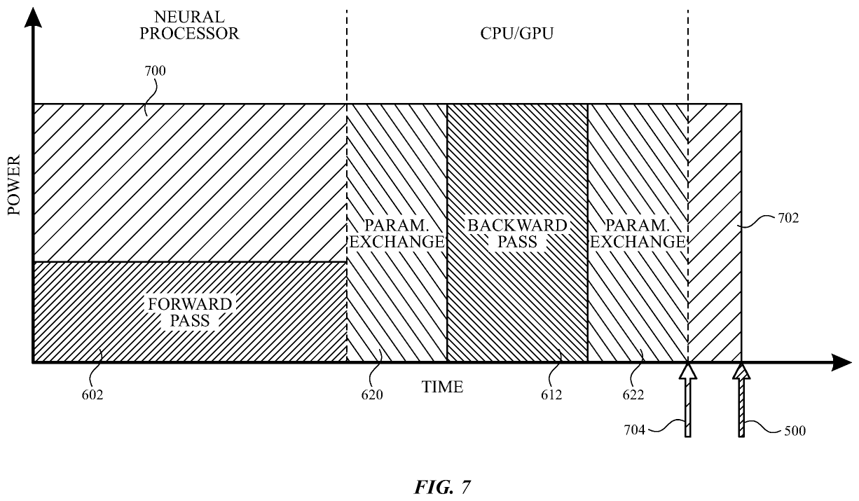

FIG. 7 illustrates a time-power diagram that shows how the multi-processor training operations described in connection with FIG. 6 can provide time and power savings relative to the training operations described in connection with FIGS. 3 and 5. As shown in FIG. 7, a forward pass 602 performed by a neural processor such as neural processor 212 may consume less power per unit time, and can be performed in less time, than a forward pass 302 performed by a CPU or GPU. This can result in a power savings 700, as illustrated in FIG. 7. FIG. 7 also shows how, although the CPU (or GPU) may perform additional parameter exchange operations 620 and additional parameter exchange operations 622, respectively before and after the backward pass 612 (and although the CPU training operation of FIG. 3 does not include such parameter exchange operations), the overall training operation completes in a total time 704 that is less than the total time 500 for the training operation of FIGS. 3 and 5. This reduced total processing time results in an additional time and power savings 702, as illustrated in FIG. 7.

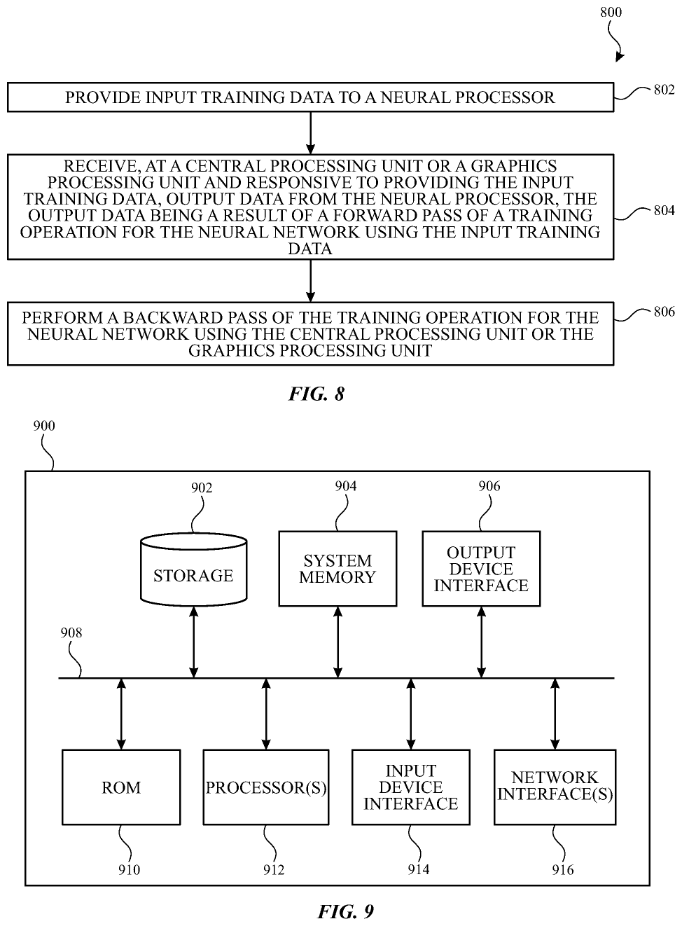

FIG. 8 illustrates a flow diagram of an example process for multi-processor training of neural networks in accordance with one or more implementations. For explanatory purposes, the process 800 is primarily described herein with reference to the electronic device 110 of FIG. 1. However, the process 800 is not limited to the electronic device 110 of FIG. 1, and one or more blocks (or operations) of the process 800 may be performed by one or more components of the server 120 and/or by other suitable devices. Further for explanatory purposes, the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

At block 802, input training data such as input training data 210-1 of FIG. 7 may be provided (e.g., by processing circuitry 208 of FIG. 2) to a neural processor such as neural processor 212. The processing circuitry may include a central processing unit such as CPU 204, a graphics processing unit such as GPU 206, and/or the neural processor 212.

At block 804, a central processing unit such as CPU 204 or a graphics processing unit such as GPU 206 may receive, responsive to providing the input training data, output data from the neural processor. The output data (e.g., model output 604) may be a result of a forward pass (e.g., forward pass 602) of a training operation for the neural network using the input training data. The output data may be the result of the forward pass 602 of the training operation using a set of parameters of the neural network. During the forward pass 602 of the training operation, intermediate data (e.g., intermediate data 230) generated by the neural processor may be stored (e.g., in memory 200 and/or 214). The processing circuitry 208 may be configured to provide access, by the central processing unit or the graphics processing unit during the backward pass 612, to the intermediate data 230 stored in the memory

The central processing unit or the graphics processing unit may also compare the output data with output training data (e.g., output training data 210-2) using a loss function such as loss function 608 of FIG. 6.

At block 806, a backward pass (e.g., backward pass 612) of the training operation for the neural network may be performed using the central processing unit or the graphics processing unit. Performing the backward pass of the training operation may include computing, with the central processing unit or the graphics processing unit, a gradient of the loss function associated with at least one of the parameters.

In one or more implementations, the operations of blocks 802, 804, and 806 may be repeated until convergence, or substantial convergence, of the model parameters. For example, the central processing unit or the graphics processing unit may update the set of parameters based on the comparison of the output data with the output training data, and based on the gradient of the loss function. The updated set of parameters may be provided to the neural processor 212 (e.g., after undergoing parameter exchange operations 622 at the central processing unit or the graphics processing unit).

The central processing unit or the graphics processing unit may then receive, responsive to providing the updated set of parameters, additional output data (e.g., an additional model output 604 generated using the updated set of parameters) from the neural processor 212. The additional output data may be a result of a forward pass 602 of an additional training operation for the neural network using the input training data (e.g., using a next mini batch of the input training data) and the updated set of parameters. The central processing unit or the graphics processing unit may then perform a backward pass of the additional training operation for the neural network.

In one or more implementations, the central processing unit or the graphics processing unit is arranged to perform floating point computations with a first precision, the neural processor is arranged to perform floating point computations with a second precision. For example, the first precision is higher than the second precision. In these implementations, the updated set of parameters from the central processing unit or the graphics processing unit may be modified in a parameter exchange operation 622, for use in computations with the second precision by the neural processor.

Although various examples are described herein in which a forward pass of a neural network is performed by a neural processor and a backward pass of the neural network is performed by a CPU or a GPU (e.g., of the same device), it should be appreciated that other multi-processor training processes are contemplated that can also provide time and/or power savings (e.g., processes in which a forward pass of a neural network is performed by a GPU and a backward pass of the neural network is performed by a CPU, such as in devices that do not include a neural processor).

The present disclosure recognizes that the use of such personal information data, in the present technology, can be used to the benefit of users. For example, the personal information data can be used for multi-processor training of neural networks.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of multi-processor training of neural networks, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 9 illustrates an electronic system 900 with which one or more implementations of the subject technology may be implemented. The electronic system 900 can be, and/or can be a part of, the electronic device 110, and/or the server 120 shown in FIG. 1. The electronic system 900 may include various types of computer readable media and interfaces for various other types of computer readable media. The electronic system 900 includes a bus 908, one or more processing unit(s) 912, a system memory 904 (and/or buffer), a ROM 910, a permanent storage device 902, an input device interface 914, an output device interface 906, and one or more network interfaces 916, or subsets and variations thereof.

The bus 908 collectively represents all system, peripheral, and chipset buses that communicatively connect the numerous internal devices of the electronic system 900. In one or more implementations, the bus 908 communicatively connects the one or more processing unit(s) 912 with the ROM 910, the system memory 904, and the permanent storage device 902. From these various memory units, the one or more processing unit(s) 912 retrieves instructions to execute and data to process in order to execute the processes of the subject disclosure. The one or more processing unit(s) 912 can be a single processor or a multi-core processor in different implementations.

The ROM 910 stores static data and instructions that are needed by the one or more processing unit(s) 912 and other modules of the electronic system 900. The permanent storage device 902, on the other hand, may be a read-and-write memory device. The permanent storage device 902 may be a non-volatile memory unit that stores instructions and data even when the electronic system 900 is off. In one or more implementations, a mass-storage device (such as a magnetic or optical disk and its corresponding disk drive) may be used as the permanent storage device 902.

In one or more implementations, a removable storage device (such as a floppy disk, flash drive, and its corresponding disk drive) may be used as the permanent storage device 902. Like the permanent storage device 902, the system memory 904 may be a read-and-write memory device. However, unlike the permanent storage device 902, the system memory 904 may be a volatile read-and-write memory, such as random access memory. The system memory 904 may store any of the instructions and data that one or more processing unit(s) 912 may need at runtime. In one or more implementations, the processes of the subject disclosure are stored in the system memory 904, the permanent storage device 902, and/or the ROM 910. From these various memory units, the one or more processing unit(s) 912 retrieves instructions to execute and data to process in order to execute the processes of one or more implementations.

The bus 908 also connects to the input and output device interfaces 914 and 906. The input device interface 914 enables a user to communicate information and select commands to the electronic system 900. Input devices that may be used with the input device interface 914 may include, for example, alphanumeric keyboards and pointing devices (also called “cursor control devices”). The output device interface 906 may enable, for example, the display of images generated by electronic system 900. Output devices that may be used with the output device interface 906 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 9, the bus 908 also couples the electronic system 900 to one or more networks and/or to one or more network nodes, such as the electronic device 110 shown in FIG. 1, through the one or more network interface(s) 916. In this manner, the electronic system 900 can be a part of a network of computers (such as a LAN, a wide area network (“WAN”), or an Intranet, or a network of networks, such as the Internet. Any or all components of the electronic system 900 can be used in conjunction with the subject disclosure.

In accordance with aspects of the disclosure, a device is provided that includes a memory; and processing circuitry that includes a central processing unit or a graphics processing unit, where the processing circuitry is configured to train a neural network by: providing input training data to a neural processor; receiving, responsive to providing the input training data, output data from the neural processor, the output data being a result of a forward pass of a training operation for the neural network using the input training data; and performing a backward pass of the training operation for the neural network using the central processing unit or the graphics processing unit.

In accordance with aspects of the disclosure, a method is provided that includes providing input training data to a neural processor; receiving, at a central processing unit or a graphics processing unit and responsive to providing the input training data, output data from the neural processor, the output data being a result of a forward pass of a training operation for the neural network using the input training data; and performing a backward pass of the training operation for the neural network using the central processing unit or the graphics processing unit.

In accordance with aspects of the disclosure, a non-transitory machine-readable medium is provided including code that, when executed by one or more processors, causes the one or more processors to: provide input training data to a neural processor; receive, at a central processing unit or a graphics processing unit and responsive to providing the input training data, output data from the neural processor, the output data being a result of a forward pass of a training operation for the neural network using the input training data; and perform a backward pass of the training operation for the neural network using the central processing unit or the graphics processing unit.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM.

The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A device, comprising:
a memory; and
processing circuitry that includes a central processing unit or a graphics processing unit;
wherein the processing circuitry is configured to train a neural network by:
providing input training data to a neural processor;
receiving, responsive to providing the input training data, output data from the neural processor, the output data being a result of a forward pass of a training operation for the neural network using the input training data; and
performing a backward pass of the training operation for the neural network using the central processing unit or the graphics processing unit.

2. The device of claim 1, wherein the output data is the result of the forward pass of the training operation using a set of parameters of the neural network.

3. The device of claim 2, wherein the processing circuitry is further configured to compare, with the central processing unit or the graphics processing unit, the output data with output training data using a loss function.

4. The device of claim 3, wherein performing the backward pass of the training operation comprises computing, with the central processing unit or the graphics processing unit, a gradient of the loss function associated with at least one of the parameters.

5. The device of claim 4, further comprising memory configured to store intermediate data generated by the neural processor during the forward pass of the training operation, and wherein the processing circuitry is further configured to provide access, by the central processing unit or the graphics processing unit during the backward pass, to the intermediate data stored in the memory.

6. The device of claim 5, wherein the central processing unit or the graphics processing unit is arranged to perform computations using a first data layout, wherein the neural processor is arranged to perform computations with a second data layout that is different from the first data layout, and wherein the processing circuitry is further configured to modify the intermediate data generated by the neural processor using the second data layout for computations by the central processing unit or the graphics processing unit using the first data layout.

7. The device of claim 4, wherein the processing circuitry is further configured to:
update, with the central processing unit or the graphics processing unit, the set of parameters based on the compare of the output data with the output training data and based on the gradient of the loss function;
provide the updated set of parameters to the neural processor;
receive, responsive to providing the updated set of parameters, additional output data from the neural processor, the additional output data being a result of a forward pass of an additional training operation for the neural network using the input training data and the updated set of parameters; and
perform a backward pass of the additional training operation for the neural network using the central processing unit or the graphics processing unit.

8. The device of claim 7, wherein the central processing unit or the graphics processing unit is arranged to perform floating point computations with a first precision, wherein the neural processor is arranged to perform floating point computations with a second precision, and wherein the first precision is higher than the second precision.

9. The device of claim 8, wherein the processing circuitry is further configured to modify the updated set of parameters from the central processing unit or the graphics processing unit for use in computations with the second precision by the neural processor.

10. The device of claim 1, wherein the processing circuitry further comprises the neural processor.

11. A method comprising:
providing input training data for a neural network to a neural processor;
receiving, at a central processing unit or a graphics processing unit and responsive to providing the input training data, output data from the neural processor, the output data being a result of a forward pass of a training operation for the neural network using the input training data; and
performing a backward pass of the training operation for the neural network using the central processing unit or the graphics processing unit.

12. The method of claim 11, wherein the output data is the result of the forward pass of the training operation using a set of parameters of the neural network.

13. The method of claim 12, further comprising comparing, with the central processing unit or the graphics processing unit, the output data with output training data using a loss function.

14. The method of claim 13, wherein performing the backward pass of the training operation comprises computing, with the central processing unit or the graphics processing unit, a gradient of the loss function associated with at least one of the parameters.

15. The method of claim 14, further comprising storing intermediate data generated by the neural processor during the forward pass of the training operation, and providing access, by the central processing unit or the graphics processing unit during the backward pass, to the stored intermediate data.

16. The method of claim 14, further comprising:
updating, with the central processing unit or the graphics processing unit, the set of parameters based on the comparing of the output data with the output training data and based on the gradient of the loss function;
providing the updated set of parameters to the neural processor;
receiving, responsive to providing the updated set of parameters, additional output data from the neural processor, the additional output data being a result of a forward pass of an additional training operation for the neural network using the input training data and the updated set of parameters; and
performing a backward pass of the additional training operation for the neural network using the central processing unit or the graphics processing unit.

17. The method of claim 16, further comprising modifying a precision of the updated set of parameters from the central processing unit or the graphics processing unit for use in computations with the neural processor.

18. A non-transitory machine-readable medium comprising code that, when executed by one or more processors, causes the one or more processors to:
provide input training data for a neural network to a neural processor;
receive, at a central processing unit or a graphics processing unit and responsive to providing the input training data, output data from the neural processor, the output data being a result of a forward pass of a training operation for the neural network using the input training data; and
perform a backward pass of the training operation for the neural network using the central processing unit or the graphics processing unit.

19. The non-transitory machine-readable medium of claim 18, wherein the output data is the result of the forward pass of the training operation using a set of parameters of the neural network.

20. The non-transitory machine-readable medium of claim 19, wherein the code, when executed by the one or more processors, further causes the one or more processors to compare, with the central processing unit or the graphics processing unit, the output data with output training data using a loss function.

21. The non-transitory machine-readable medium of claim 20, wherein performing the backward pass of the training operation comprises computing, with the central processing unit or the graphics processing unit, a gradient of the loss function associated with at least one of the parameters.
